(19) United States
(12) Patent Application Publication
(10) Pub. No.: US 2026/0073446 A1
(43) Pub. Date: Mar. 12, 2026

(54) REAL-TIME MULTIPLE-ACCESS EXCHANGE-PARTY-FREE COUNTERPARTY-SECURE EXCHANGE

(71) Applicants: Jeff Jay Hilde, Martinsburg, PA (US); Austin Lee Hilde, Hayden, CO (US); Brandon James Hilde, Sandy, OR (US)

(72) Inventors: Jeff Jay Hilde, Martinsburg, PA (US); Austin Lee Hilde, Hayden, CO (US); Brandon James Hilde, Sandy, OR (US)

(21) Appl. No.: 19/389,763

(22) Filed: Nov. 14, 2025

Related U.S. Application Data
(63) Continuation-in-part of application No. 18/146,716, filed on Dec. 27, 2022, now abandoned.
(60) Provisional application No. 63/263,116, filed on Oct. 27, 2021.

(51) Int. Cl. G06Q 40/04; G06Q 20/06; G06Q 20/36; G06Q 20/38

(52) U.S. Cl. CPC G06Q 40/04; G06Q 20/0658; G06Q 20/389; G06Q 20/3678

(57) ABSTRACT

A decentralized multi-blockchain crypto exchange system includes a crypto exchange medium hosted at native addresses on each blockchain network, a protocol-based balance tracker, hold and release mechanisms, and a relay consensus component. The system tracks user balances and enforces asset custody, using protocol-based holds to lock assets until specific conditions are met. The relay consensus component generates and synchronizes relay proof values across blockchains, ensuring that all transfers succeed or revert collectively, preventing partial execution of cross-chain exchanges. Exchange orders are placed through peer-to-peer channels, specifying asset amounts and market-volume-based expiration criteria, with unmatched orders canceled when cumulative trading volume thresholds are reached. This design eliminates the need for off-chain servers, reducing latency and improving security. The system facilitates trustless, efficient cross-chain transactions, reduces counterparty risk, and supports various blockchain types, including proof-of-work and proof-of-stake networks, making the system appropriate for secure and scalable asset exchanges.

### CROSS-REFERENCE TO RELATED APPLICATION

This application is a continuation-in-part of U.S. application Ser. No. 18/146,716, filed Dec. 27, 2022, the contents of which are herein incorporated by reference. Application Ser. No. 18/146,716 claimed the benefit of priority of U.S. provisional application No. 63/263,116, filed Oct. 27, 2021, the contents of which are herein incorporated by reference.

### BACKGROUND OF THE INVENTION

The present disclosure pertains to blockchain technologies, and more particularly to secure multi-blockchain exchange systems designed to eliminate intermediary exchange parties and mitigate double exchange fraud.

As illustrated in FIG. 1, prior art centralized exchange systems rely on centralized liquidity pools and custody, exposing user assets to significant risks associated with centralized control, such as insider threats, hacking, and single points of failure. In these systems, user devices interact with a central exchange, and all asset custody and transaction processing are managed by the central entity. Decentralized exchanges, as depicted in FIG. 2, have introduced improvements by distributing liquidity across multiple blockchains through interconnected smart contracts, thereby reducing the risk of a single point of failure. However, these prior art decentralized systems often depend on intermediary components such as bridge servers to coordinate cross-chain transactions. While decentralized liquidity pools (low risk decentralized liquidity) provide enhanced security for on-chain transactions within a single blockchain, the use of a bridge server device introduces a potential vulnerability, as it can be targeted for attacks or exploited by malicious actors. This reliance on a hackable intermediary limits the overall trustlessness and security of the system.

Present methodologies are generally optimized for transaction operations within a single blockchain, where established protocols prevent duplicate or unauthorized spending. When facilitating exchanges between distinct blockchain environments, these methods frequently depend on external coordination—such as centralized servers or bridge devices—to manage separate transfer processes. This reliance introduces operational complexities and potential vulnerabilities, particularly during the synchronization of independent transactions.

Various systems have been developed that utilize intermediary services to bridge the gap between disparate blockchain networks. For example, US20190340586 describes a system for conducting cross-blockchain currency transactions using a server to orchestrate sequences of trades across multiple exchanges, leveraging machine learning to optimize conversion paths and manage temporary custody of assets. While these approaches benefit from the security characteristics associated with each individual blockchain, their segmented process often generates timing discrepancies. The asynchronous nature of validation across different networks thereby compromises the coordination of interrelated transfers and introduces risks associated with centralized or intermediary components, such as potential insider fraud or hacking.

Other solutions, such as those described in US20210326869, employ protocols like Hash Time Locked Contracts (HTLCs) to facilitate atomic swaps between blockchains. These methods identify and associate related transactions across multiple blockchain networks to derive hidden information and attempt to ensure that cross-chain transactions are executed without the need for a trusted intermediary. While HTLCs are designed to reduce counterparty risk and prevent one-sided fraud in atomic swaps, they are not immune to all forms of fraud. Timing issues, improper implementation, or network delays can still result in failed or incomplete exchanges, potentially exposing parties to loss or exploitation.

Additionally, U.S. Pat. No. 11,410,233 addresses the use of blockchain technology to expedite settlement of securities traded on exchanges. This reference describes the use of cryptographically signed clearing instructions and the generation of data blocks within a blockchain to enable real-time or near real-time gross settlement of trades, with mechanisms to prevent double spending. While this approach streamlines settlement within a single or hierarchical ledger system, the complexities of coordinating asset transfers across multiple independent blockchain networks remain unaddressed, and the absence of atomicity or synchronization between independent systems can still allow for certain types of fraud or failed settlements.

In summary, while each of these existing systems implements mechanisms to reduce or manage fraud risk within their respective domains, none fully eliminate the possibility of fraud-especially in the context of cross-blockchain or multi-party exchanges where timing, synchronization, and reliance on intermediaries or external protocols can introduce vulnerabilities.

Accordingly, there remains a need for a streamlined framework that facilitates simultaneous, secure transfers across multiple blockchain platforms without reliance on intermediary parties, thereby synchronizing the settlement of interdependent transactions and addressing the shortcomings of both centralized and prior art decentralized approaches.

### SUMMARY OF THE INVENTION

In one embodiment, the present system provides a decentralized multi-blockchain crypto exchange framework that includes a plurality of blockchain networks, each hosting a crypto exchange medium at native network addresses and configured to interact with the networks' native assets. This framework employs a protocol-based mechanism to track balances of both the exchange medium and native assets, while a protocol-based hold mechanism restricts transferability of committed funds without resorting to hash-time-locked contracts. Moreover, a complementary protocol-based release mechanism restores transferability upon fulfillment or expiration of exchange conditions. A market-liquidity-based reservation criterion further controls activation and expiration of exchange orders. In addition, a multi-blockchain relay consensus component generates relay proof values via one or more consensus methods, identifies a maximum proof value to trigger release of holds, and broadcasts that value for network-wide synchronization. As a result, cross-chain exchange transactions execute atomically, ensuring that all transfers either succeed together or revert together.

In another embodiment, the present disclosure provides a method for atomic exchange of crypto assets across multiple blockchain networks. The method comprises: receiving a first exchange order on a first network and a second exchange order on a second network, each order specifying amounts of a crypto exchange medium and native assets; placing on-chain holds on the specified amounts without using hash-time-locked contracts; generating relay proof values on each network via a multi-blockchain relay consensus mechanism; determining and broadcasting the maximum relay proof value to synchronize release conditions; releasing the holds concurrently to transfer the specified amounts upon confirmation of complementary transfers; and invalidating any unmatched orders when the cumulative trading volume of the crypto exchange medium reaches a predetermined market-volume-based expiration threshold. Notably, no off-chain order-routing server is involved in executing the exchange.

In further embodiments, the system and method may employ an internal ledger maintained at each address, wrapped tokens that mirror native assets, on-chain state flags in smart contracts for holds and releases, a blockchain-native peer-to-peer messaging protocol for exchange orders from cryptographic wallets, and liquidity-pool contracts that commingle exchange medium with native assets. Additionally, the architecture can support more than two networks of varying consensus types (proof-of-work, proof-of-stake, or others), divide assets into multiple divisions for atomic matching, allow unilateral initiation of orders without prior counterparty coordination, and activate or invalidate orders based on specified cumulative trading-volume thresholds.

The described method for securing cross-chain asset exchanges employs a unilateral approach that diverges from bilateral methods, such as Hash Time Locked Contracts (HTLCs), by removing the requirement for mutual agreement or shared cryptographic secrets between parties. HTLCs utilize a bilateral structure where both parties coordinate using pre-agreed hash values and time locks to facilitate atomicity, which introduces challenges such as timing discrepancies, network delays, and risks of incomplete transactions. Instead, the described method utilizes protocol-based holds that are independently enforced at the smart contract level, relying on on-chain state flags to restrict asset transfers until predefined conditions are satisfied. This unilateral approach allows each transfer to be autonomously secured without necessitating direct interaction or trust between the parties, thereby mitigating counterparty risk and addressing vulnerabilities tied to bilateral coordination. Through the use of immutable protocol operations, the method enables atomic execution of transactions across multiple blockchains with enhanced simplicity, reliability, and resistance to fraud.

These and other features, aspects and advantages of the present invention will become better understood with reference to the following drawings, description and claims.

### BRIEF DESCRIPTION OF THE DRAWINGS

FIG. 1 is a network diagram illustrating the interaction between a liquidity pool and multiple user devices within a decentralized exchange system as previously known;

FIG. 2 is a schematic view of a decentralized liquidity system facilitating interactions among user devices and distributed liquidity nodes from existing systems;

FIG. 3 is a network diagram illustrating direct communication between user devices without intermediary bridge or server devices according to an embodiment of the present disclosure;

FIG. 4 is a flowchart diagram of the proof of relay process for determining and broadcasting the maximum proof value in a multi-blockchain exchange system according to an embodiment of the present disclosure;

FIG. 5 is a process diagram of a blockchain transaction showcasing user-initiated actions and automated reactions for asset transfers between Blockchain X and Blockchain Y according to an embodiment of the present disclosure;

FIG. 6 is a block diagram representation of a blockchain network structure, showcasing the flow of transactions, orders, and blocks within the canonical blockchain network according to an embodiment described herein;

FIG. 7 is a block diagram illustrating the blockchain network structure and the components of the blockchain network, including candidate blocks, confirmed blocks, and associated orders related to those blocks according to an embodiment of the present disclosure;

FIG. 8 is a block diagram illustrating the blockchain network structure and the components of the blockchain network, including interconnected nodes, blocks, and mirrored networks according to an embodiment of the present disclosure;

FIG. 9 is a block diagram illustrating blockchain components, including canonical and mirror blockchain structures, ledger elements, and order history according to an embodiment of the present disclosure;

FIG. 10 is a block diagram illustrating the structure of a mirror blockchain, including the volume, liquidity, ledger, and order history components associated with the mirror blockchain according to an embodiment of the present disclosure;

FIG. 11 is a block diagram illustrating the components of a blockchain system, including mirror blockchain structures, liquidity, ledger, and order history according to an embodiment of the present disclosure;

FIG. 12 is a blockchain transaction message structure diagram representing a buy order with associated holding, liquidity reservation, and volume expiration parameters according to an embodiment of the present disclosure;

FIG. 13 is a block diagram of a blockchain transaction message structure, including a sell order, holding order, liquidity reservation, and volume expiration according to an embodiment of the present disclosure;

FIG. 14 is a block diagram of a blockchain transaction message structure, including a fill order, delivery coin, and disbursement coin across multiple blockchains according to an embodiment described herein;

FIG. 15 is a schematic illustrating the structure of a payment coin within the decentralized multi-blockchain exchange system according to an embodiment of the present disclosure;

FIG. 16 is a schematic illustrating the structure of the order coin within the decentralized multi-blockchain exchange system according to an embodiment of the present system;

FIG. 17 is a schematic illustrating the structural details of a coin within the decentralized multi-blockchain exchange system according to an embodiment of the present disclosure;

FIG. 18 is a schematic illustrating the structure of a disbursement coin within the decentralized multi-blockchain exchange system according to an embodiment of the present system;

FIG. 19 is a flowchart of the payment and order process, detailing the division of payment and order holds into transfer divisions according to an embodiment of the present system;

FIG. 20 is a flowchart diagram detailing the payment and delivery process for transferring and releasing divisions as disbursements and deliveries in a blockchain exchange system according to an embodiment of the present disclosure;

FIG. 21 is a flowchart diagram of the crypto exchange process, including order placement, reservation, expiration, and division based on market liquidity and volume criteria according to an embodiment of the present disclosure;

FIG. 22 is a flowchart diagram of the crypto exchange process, including order placement, holding, reservation, expiration, and division steps according to an embodiment of the present disclosure;

FIG. 23 is a flowchart illustrating the SWOBL transaction process, including routing, delivery, and disbursement steps according to an embodiment of the present system;

FIG. 24 is a flowchart illustrating the process for creating, validating, and managing HoldingOrders in a decentralized multi-blockchain exchange system according to an embodiment of the present disclosure;

FIG. 25 is a flowchart diagram outlining the process steps for reserving liquidity in a decentralized multi-blockchain exchange system according to an embodiment of the present disclosure;

FIG. 26 is a flowchart illustrating the process for expiring order reservations based on cumulative trading volume thresholds according to an embodiment of the present system;

FIG. 27 is a flowchart illustrating the process for dividing and matching buy and sell orders to create FillOrder divisions according to an embodiment of the present disclosure;

FIG. 28 is a flowchart illustrating the routing process for creating and configuring FillOrders in a decentralized multi-blockchain exchange system according to an embodiment described herein; and

FIG. 29 is a flowchart illustrating the process for releasing orders in a decentralized multi-blockchain exchange system according to an embodiment of the present disclosure.

### DETAILED DESCRIPTION OF THE INVENTION

The term “comingling of foreign and native crypto assets at the same blockchain address,” as used herein, refers to the capability of a blockchain-based system to store and manage both native assets-those originally issued on the host blockchain—and foreign assets—those originating from other blockchains, such as wrapped tokens—within a single on-chain address. This arrangement allows the internal ledger of a smart contract to reflect balances for multiple token standards and asset types, thereby enabling seamless integration and transfer of diverse assets in a unified manner.

In this disclosure, a “liquidity pool” as a smart contract and central repository describes a smart contract deployed on a blockchain that functions as a central repository for user-contributed funds. The liquidity pool supports multiple token standards and is responsible for automatically managing, holding, and allocating assets to facilitate decentralized trading, lending, or cross-chain exchanges. It maintains internal ledgers to track user balances and asset types at a single on-chain address.

The phrase “protocol-based holds” is used herein to identify mechanisms implemented at the protocol or smart contract level that temporarily restrict the transfer or release of assets until certain predefined conditions are satisfied, such as the confirmation of complementary transactions across different blockchains. Unlike time-locks or secret hashes, protocol-based holds utilize on-chain state flags or escrow conditions to enforce atomicity and security in asset exchanges.

Within the context of this invention, “atomic execution of transactions across multiple blockchains” denotes a property of a cross-chain transaction system in which asset transfers on two or more independent blockchains are coordinated so that either all transfers succeed together or all are reverted. This ensures that no partial or incomplete transactions occur, thereby eliminating the risk that one party could lose assets without receiving the agreed counter-value.

The system described herein is designed to operate seamlessly across any number of blockchain networks, including scenarios where the process is executed within a single blockchain. In a multi-blockchain configuration, the system facilitates cross-chain asset exchanges by leveraging the crypto exchange medium and protocol-based mechanisms to ensure atomicity and security. However, the system is equally capable of functioning within a single blockchain environment, where the exchange process involves native assets and the crypto exchange medium hosted on that blockchain. In such cases, the protocol-based hold and release mechanisms are applied to transactions within the same blockchain, ensuring that all transfers succeed or fail together, thereby maintaining the integrity and trustlessness of the exchange. This flexibility allows the system to adapt to various blockchain architectures, whether operating in a multi-chain ecosystem or within the confines of a single blockchain, while still providing the same level of security, fraud resistance, and decentralized operation.

The expression “market volume-based expiration mechanism” is used to describe a protocol feature that invalidates unfulfilled exchange bids and asks based on the aggregate trade volume of the relevant asset or pool, rather than on elapsed time. When a specified market volume threshold is reached or exceeded, any outstanding orders that have not been matched are automatically canceled or expired.

“Invalidating unfulfilled transactions without relying on time-based constraints” refers to the process by which pending or unmatched exchange orders are canceled or rendered void based on criteria other than the passage of time-such as the attainment of a market volume threshold-thereby avoiding reliance on timeouts or deadlines for order expiration.

The term “counterparty risk,” as used in this context, explicitly refers to the risk that one party in a transaction will default on its obligations, fail to deliver assets, or otherwise act dishonestly, resulting in potential loss to the other party. In the context of decentralized exchanges, counterparty risk is mitigated by protocol mechanisms that ensure both sides of an exchange are executed atomically.

The phrase “protocol-based holds prevent double exchange fraud,” means that protocol-enforced asset holds, rather than centralized or manual controls, are used to ensure that neither party can unilaterally complete or withdraw from a cross-chain exchange. This prevents scenarios in which an intermediary or malicious actor could exploit control over both sides of a transaction to defraud the original parties.

The term “decentralized framework that is scalable and resistant to fraud” describes a system architecture in which control and validation are distributed among multiple independent nodes, with no single point of failure or control. Such a framework is designed to efficiently accommodate increasing numbers of users and transactions, while incorporating cryptographic and consensus-based safeguards to prevent fraudulent activity.

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a novel crypto medium of exchange that operates as a decentralized mechanism for securing cross-chain transactions.

A new type of crypto currency acts as the medium of exchange to replace the exchange party role. This crypto currency is referred to herein as “Swopblocks”, a super block that contains crypto blocks from multiple blockchains, the crypto blocks containing trading orders that are processed as a unit. This new currency is hosted on multiple blockchains and is used in a new type of crypto trade transaction. This inventive method provides a protocol driven exchange function that executes in decentralized autonomous processing using Swopblocks and Proof of Relay: a new type of blockchain consensus mechanism that works by first relaying a proof to start and then relaying progress of proof among network nodes in a type of relay race to randomly win the right to define and profit from the next valid Swopblock in a longest chain blockchain.

This approach eliminates intermediary exchange parties by leveraging cryptographic protocols and blockchain-native consensus mechanisms to enforce transaction atomicity. The system uses a multi-blockchain relay framework to transfer foreign crypto assets between blockchains, ensuring that both transfers in an exchange succeed or fail together. By placing a hold on asset transfers until all associated transactions are confirmed across relevant blockchains, the system prevents either party from backing out or defrauding the counterparty. This hold functionality is implemented through immutable protocol operations, rendering the system immune to double exchange fraud.

The solution enables comingling of foreign and native crypto assets at the same blockchain address, facilitating seamless integration and transfer across disparate blockchain networks. The liquidity pool, implemented as a smart contract on a blockchain network, serves as a central repository of funds within the decentralized exchange system and supports the comingling of native and foreign crypto assets at a single on-chain address. This design ensures atomic execution of transactions across multiple blockchains, with the pool temporarily holding assets during exchange transactions and placing protocol-based holds until all associated transactions are confirmed. Protections against double-spend fraud are maintained through the consensus mechanisms of the respective blockchains, and protocol-based holds prevent double exchange fraud and protect parties from counterparty risk. Additionally, the system introduces a market volume-based expiration mechanism for exchange bids and asks, invalidating unfulfilled transactions without relying on time-based constraints, thereby enhancing the efficiency and security of cross-chain exchanges and providing a decentralized framework that is scalable and resistant to fraud.

User devices interact with the liquidity pool via secure communication channels, enabling transaction initiation, bid/ask placement, and status monitoring. These devices participate in blockchain consensus mechanisms, validating transactions and contributing to the decentralized nature of the system. Communication channels ensure secure bid/ask placement and transaction confirmations, maintaining data integrity and confidentiality.

Transaction validation nodes distributed across the network verify the authenticity and validity of transactions, ensuring compliance with blockchain protocols and enforcing transaction atomicity. Decentralized liquidity operates without centralized control, relying on blockchain-native consensus mechanisms to coordinate transactions. Interconnected smart contracts manage asset transfers across blockchains, maintaining scalability and fraud resistance. Decentralized liquidity nodes interpret relay instructions embedded in blockchain transactions, ensuring secure and efficient asset transfers between blockchains. They enforce expiration mechanisms for bids and asks based on market trade volume thresholds, invalidating unfulfilled transactions to maintain system efficiency.

User devices equipped with cryptographic wallets and blockchain-native communication protocols enable secure peer-to-peer transactions, bypassing intermediary bridge or server devices. This decentralized structure reduces operational complexity and vulnerabilities, relying on blockchain-native protocols and consensus mechanisms to coordinate transactions directly between devices. The proof calculation process initializes parameters, generates cryptographic proofs using Proof-of-Stake and Proof-of-Work mechanisms, and computes relay proof values. Relay proof values are compared to determine the maximum proof value, which is broadcast to all nodes for synchronization. The process evaluates whether the next swap block offers higher rewards, continuing or concluding based on the evaluation.

The present disclosure introduces a protocol-based hold mechanism that operates unilaterally, meaning it does not require pre-agreement or coordination between the parties involved in an exchange. This approach differs significantly from Hash Time Locked Contracts (HTLCs), which are structured to be bilateral and rely on pre-existing agreements between the parties. HTLCs depend on shared cryptographic secrets and time-lock conditions, requiring both parties to coordinate and agree on specific hash values and time constraints prior to initiating the transaction. Such bilateral dependency introduces complexities, including risks of timing discrepancies, network delays, and incomplete transactions. In the current approach, the protocol-based holds are autonomously enforced at the smart contract level using on-chain state flags, ensuring that asset transfers are restricted until predefined conditions are satisfied. This removes the need for mutual agreement or shared secrets, thereby simplifying the process, reducing counterparty risk, and enhancing the decentralized nature of the system.

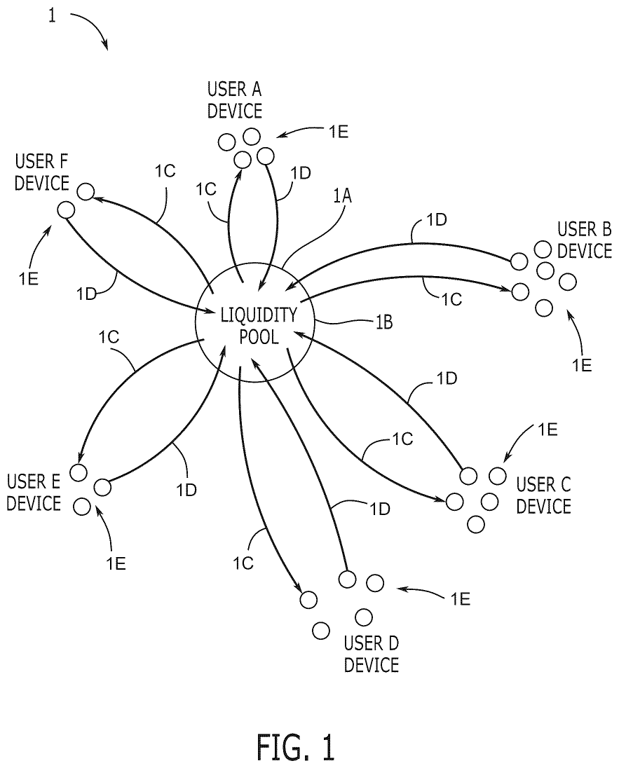

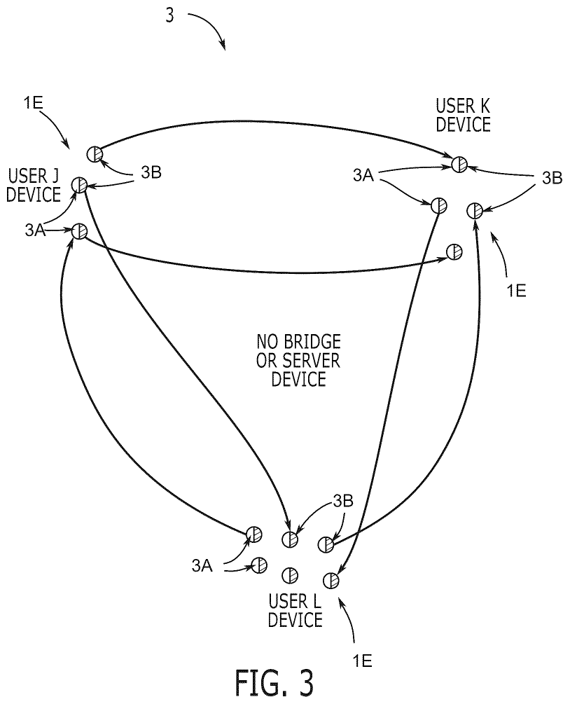

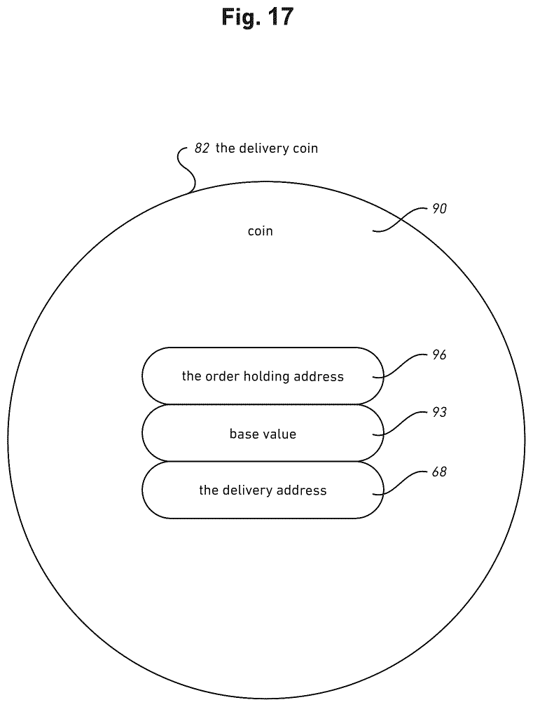

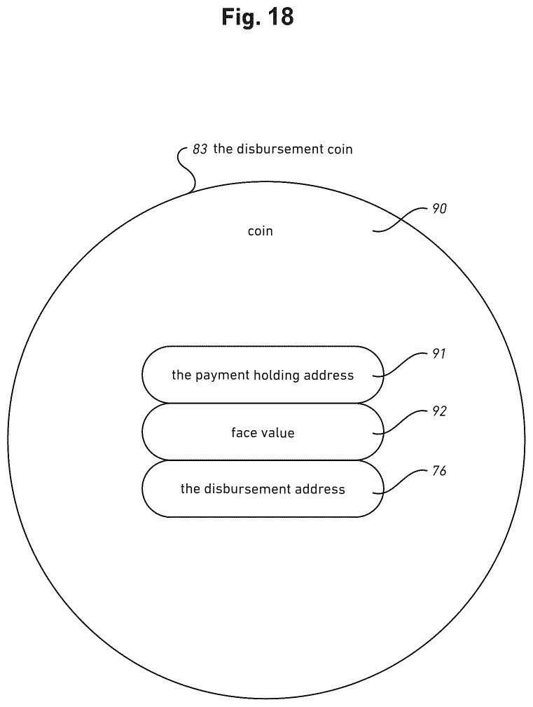

Turning to FIGS. 1-29, FIGS. 1 and 2 illustrate prior art exchange architectures, providing background on conventional centralized and decentralized systems and their associated limitations. FIGS. 3-29 depict various aspects, components, and processes of the disclosed decentralized multi-blockchain exchange system, including direct peer-to-peer communication, protocol-based holds, order structures, transaction flows, and consensus mechanisms.

FIG. 1 shows a prior art network diagram of a centralized exchange cryptocurrency trading system 1 facilitating interactions between multiple user devices. In this architecture, 1A represents a liquidity pool with higher risk centralized liquidity, while 1B denotes higher risk centralized custody. The system is managed in a centralized manner, exposing user assets to increased risks associated with centralized control and custody.

User devices (User A, User B, User C, User D, User E, User F) interact with the centralized exchange system 1 as endpoints. These devices may be equipped with blockchain wallets and cryptographic credentials for secure communication, and can initiate transactions, place bids or asks, and monitor exchange status. However, users must rely on the centralized liquidity and custody provided by 1A and 1B, which increases vulnerability to insider threats, hacking, and single points of failure.

Data channels 1C and 1D link the centralized exchange system 1 to user devices. Channel 1C represents data for bid and ask placement, while channel 1D represents data for transaction confirmations and status updates. Although these channels may use secure communication protocols, the underlying liquidity and custody remain centralized, limiting the benefits of decentralization.

Crypto coins 1E are shown distributed across the network, representing the digital assets held and transferred within the system. In this prior art model, the centralized nature of both liquidity and custody exposes users to greater counterparty and custodial risks, and does not provide the atomicity, fraud resistance, or decentralized safeguards of more advanced decentralized exchange architectures.

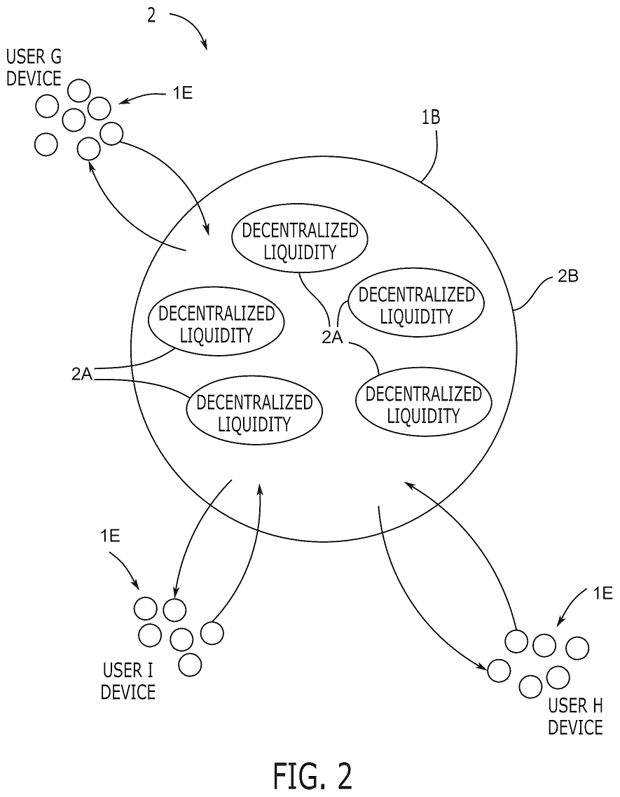

FIG. 2 shows a prior art network diagram of a crypto decentralized exchange 2, illustrating interactions among user devices and blockchain nodes. In this architecture, low risk decentralized liquidity 2A is implemented as interconnected smart contracts across multiple blockchains. This setup coordinates asset transfers between user devices (User G Device, User I Device, User H Device), allowing users to interact with the system using cryptographic wallets that support multiple blockchains for seamless cross-chain transactions.

While decentralized liquidity 2A reduces risk by distributing control and relying on blockchain-native consensus mechanisms, the system also includes a bridge server device 2B, which acts as a hackable intermediary for coordinating transactions across blockchains. The presence of this bridge server introduces a potential point of vulnerability, as it can be targeted for attacks or exploited by malicious actors.

In this prior art model, user devices participate in validation and consensus processes to enhance decentralization, but the reliance on the bridge server 2B for cross-chain coordination limits the system's overall security and trustlessness. Although decentralized liquidity 2A operates without a single point of control for the liquidity itself, the bridge server device 2B remains a critical component and potential risk factor in the architecture.

FIG. 3 shows a schematic diagram of a decentralized crypto-swap block exchange system, illustrating direct communication between user devices (USER J DEVICE, USER K DEVICE, USER L DEVICE) without any intermediary bridge or server device. Each user device is equipped with cryptographic wallets and blockchain-native communication protocols, enabling secure peer-to-peer transactions and facilitating atomic swaps directly between blockchains. The absence of intermediary components such as a bridge or server device reduces operational complexity and eliminates vulnerabilities associated with centralized points of failure. Decentralized custody 3A and decentralized liquidity 3B are provided at each user device, ensuring that users retain control over their assets throughout the exchange process. Crypto coins 1E represent the digital assets held and transferred by the user devices within the system.

Communication occurs directly between the user devices, enabling secure, tamper-proof, and real-time exchange of transaction data, cryptographic proofs, and confirmations. The peer-to-peer nature of these interactions supports the decentralized structure of the system.

The absence of a bridge or server device in the network diagram underscores the decentralized architecture, eliminating centralized control and enhancing both scalability and resistance to fraud. This embodiment leverages the crypto medium of exchange to enforce transaction atomicity and applies protocol-based holds on transfers until all associated transactions are confirmed, thereby protecting both parties from counterparty risk.

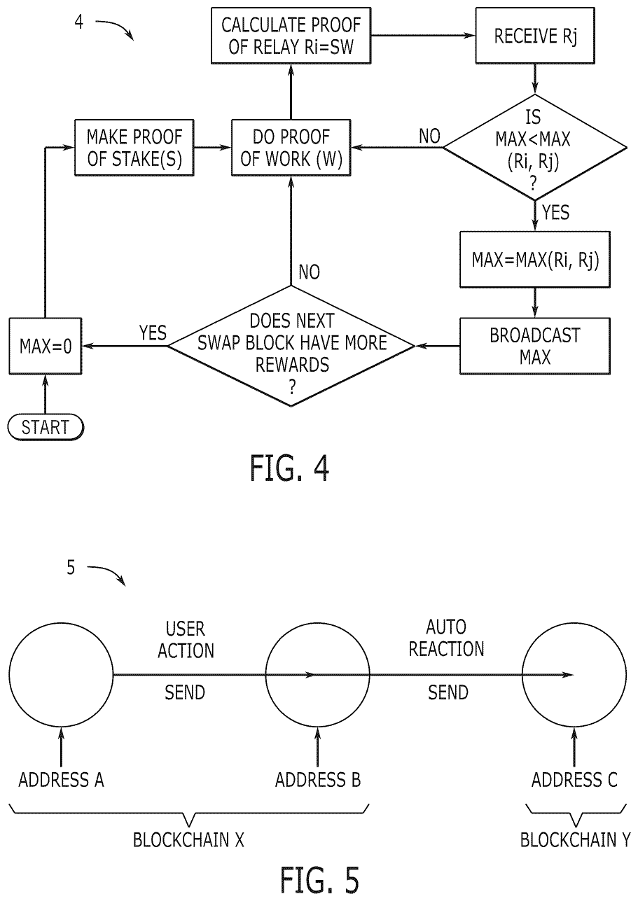

FIG. 4 shows a flowchart 4 for calculating and broadcasting the maximum proof value in a multi-blockchain exchange system. The process begins with initialization of proof calculation parameters, including the initial proof value and blockchain addresses. MAX=0 initializes the maximum proof value. The MAKE PROOF OF STAKE(S) component generates cryptographic proofs based on Proof-of-Stake, validating transaction authenticity and integrity. The DO PROOF OF WORK (W) component generates cryptographic proofs based on Proof-of-Work, ensuring resistance to tampering and fraud.

The CALCULATE PROOF OF RELAY Ri=SW component computes the relay proof value by combining the cryptographic proofs. The RECEIVE Rj component collects relay proof values from other nodes, which are compared to determine the maximum proof value. If the current maximum is less than the maximum of the locally calculated and received values, MAX is updated. The BROADCAST MAX component disseminates the maximum proof value to all nodes for synchronization. The process evaluates whether the next swap block offers higher rewards; if so, the process continues, otherwise, the current block is concluded. This method leverages the multi-blockchain relay framework to coordinate and confirm transactions, integrating PoS and PoW for security and decentralization, preventing double exchange fraud and ensuring atomicity.

FIG. 5 illustrates a concurrent send transaction 5 in the blockchain exchange system. Here, Address A on Blockchain X initiates a user action, sending assets to Address B, which then automatically triggers a transfer to Address C on Blockchain Y. This process is coordinated by the Swopblock crypto medium of exchange, which links transactions to bid offers and enforces protocol-based holds until all associated transfers are confirmed, ensuring atomicity.

The relay mechanism interprets transaction instructions to synchronize asset transfers across blockchains, while consensus protocols validate and finalize the exchange. Crypto coins 1E represent the assets in transit, and data channels 1C and 1D convey bid/ask and confirmation data between user devices and the system.

Overall, FIG. 5 demonstrates a decentralized architecture that eliminates intermediary exchange parties and mitigates double exchange fraud through cryptographic protocols and consensus mechanisms.

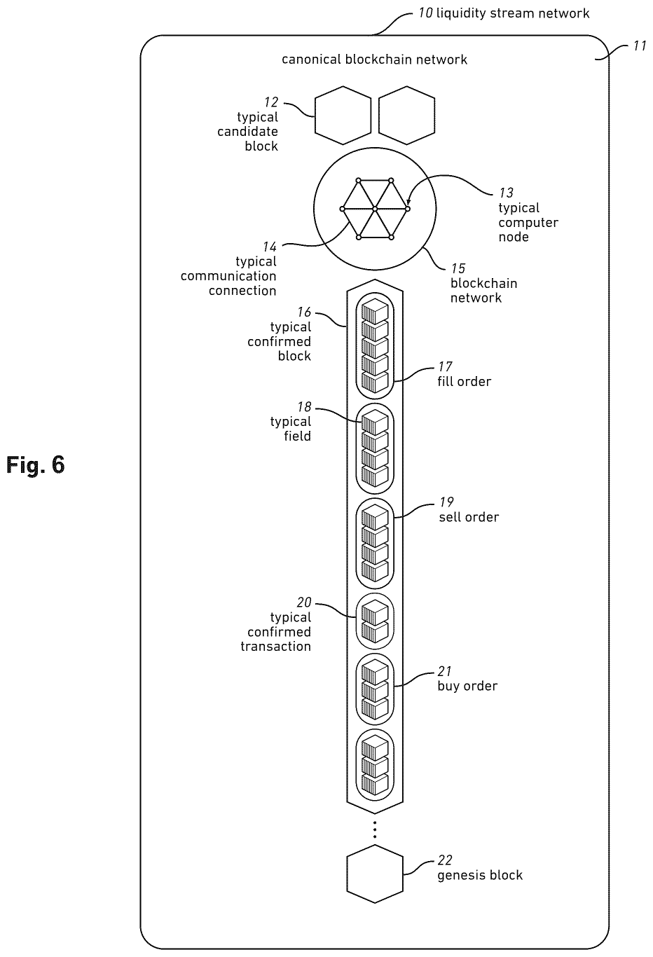

FIGS. 6, 7, 8, 9, 10, and 11 provide structural representations of blockchain networks, including network nodes 13, user devices, smart contracts, and communication links 14. These figures collectively outline the decentralized architecture, emphasizing the interconnectedness of system entities. Network nodes 13 validate transactions and enforce protocol-based holds, while user devices equipped with cryptographic wallets interact with smart contracts to initiate and monitor exchanges. Communication links 14 ensure secure data transmission, maintaining system integrity and scalability.

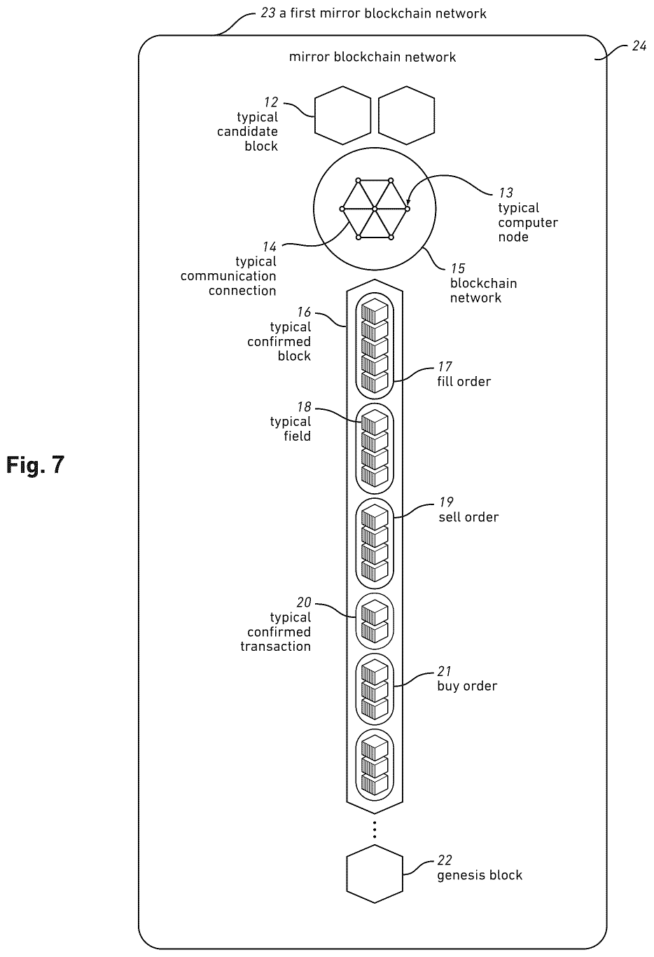

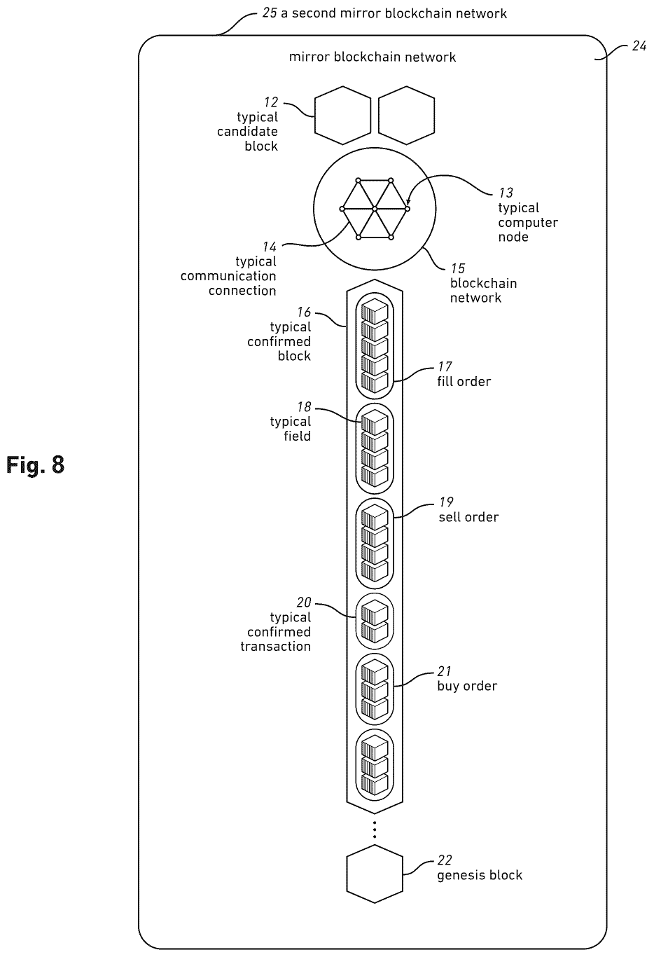

FIGS. 6, 7, and 8 provide structural representations of blockchain networks, including network nodes 12, 15, and 22, which represent various types of nodes participating in transaction validation, consensus, and relay operations within the system. FIG. 6 illustrates the structure of a canonical blockchain, which serves as the primary ledger for recording transactions and maintaining the integrity of native crypto assets. In FIG. 6, elements 10 and 11 denote the canonical blockchain and its associated ledger, serving as the primary record of native asset transactions. The canonical blockchain operates as the definitive source of truth, utilizing consensus mechanisms such as Proof-of-Work (PoW) or Proof-of-Stake (PoS) to validate transactions and prevent double-spend fraud. FIGS. 7 and 8, on the other hand, depict mirror blockchains, which are auxiliary ledgers designed to replicate and extend the functionality of the canonical blockchain. In FIG. 7, elements 23 and 24 illustrate components of the mirror blockchain, such as the mirrored ledger and associated relay mechanisms that facilitate cross-chain synchronization. In FIG. 8, elements 25 and 24 represent additional mirror blockchain structures and their corresponding relay or synchronization components. Mirror blockchains enable the comingling of foreign crypto assets with native crypto assets at the same blockchain address, ensuring deterministic behavior and compatibility with native blockchain operations. These mirror blockchains facilitate cross-chain transactions by interpreting relay instructions embedded in canonical blockchain transactions, thereby enabling secure and synchronized asset transfers between independent blockchain networks. All three schematics—FIG. 6, FIG. 7, and FIG. 8—illustrate the recordation of a buy order 21, a confirmed transaction 20, a sell order 19, another field 18, and a fill order 17 in a confirmed block 16. Together, the canonical and mirror blockchains provide a cohesive framework for decentralized multi-blockchain exchanges, ensuring atomicity, fraud resistance, and seamless integration across diverse blockchain ecosystems.

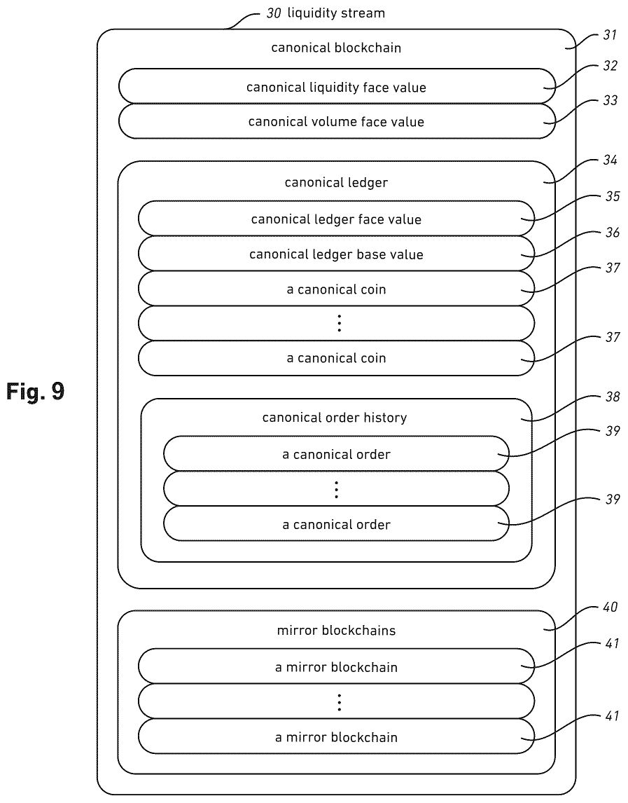

FIG. 9 is a block diagram illustrating a liquidity stream 30 which represents the flow of assets available for exchange within the system. A canonical blockchain 31 serves as the primary ledger for recording transactions and maintaining the integrity of native crypto assets. A liquidity face value 32 denotes the quantifiable amount of liquidity available for trading operations. A volume face value 33 tracks the cumulative trading volume of assets, supporting market-volume-based expiration mechanisms. A canonical ledger 34 records and maintains the balances and transaction history associated with the canonical blockchain 31. The face value 35 of the canonical ledger 34 represents the nominal value of assets recorded in the ledger, while the base value 36 of the canonical ledger 34 indicates the underlying value used for settlement and accounting purposes. A canonical coin 37 is a representation of a native asset within the canonical blockchain 31. A canonical order history 38 maintains a record of all exchange orders processed on the canonical blockchain 31, including each canonical order 39 as an individual entry within this history. A plurality of mirror blockchains 40 operate alongside the canonical blockchain 31 to support cross-chain operations and asset synchronization, with 41 representing the individual mirror blockchains within this plurality.

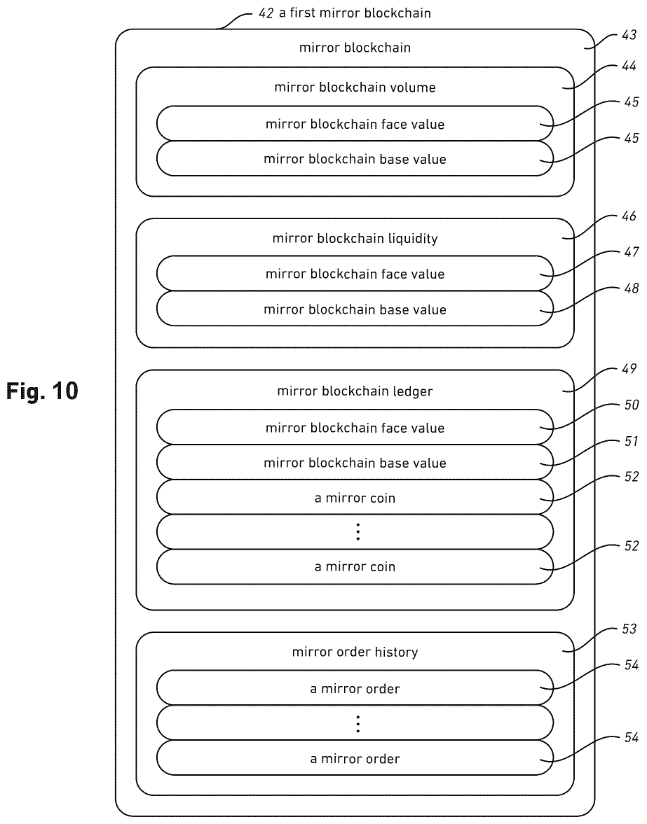

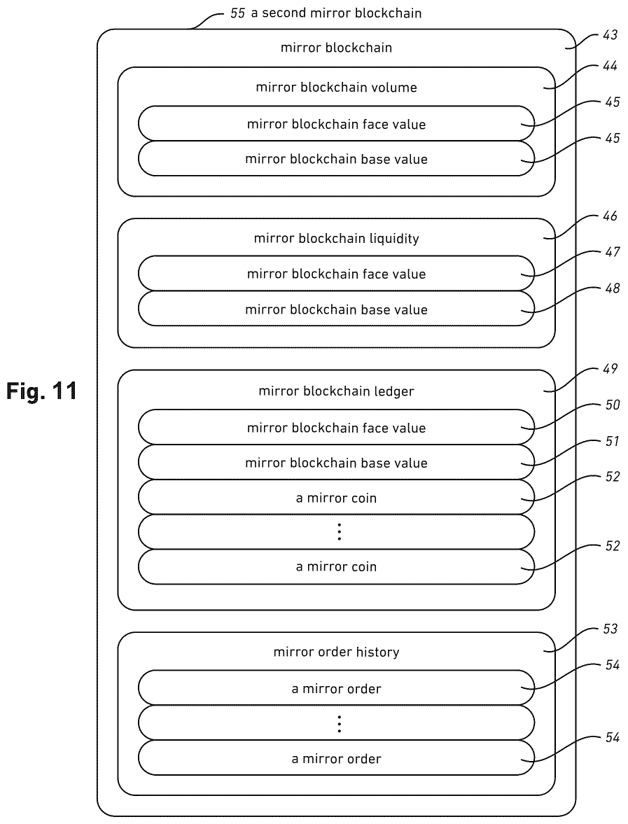

Turning to FIGS. 10-11, a first mirror blockchain 42 and a second mirror blockchain 55 are shown, with each mirror blockchain 43 including a volume 44 having both a face value and a base value of the volume labeled 45. A liquidity 46 is also maintained, with a liquidity face value 47 and a liquidity base value 48. A ledger 49 is included, which contains a face value 50, a base value 51, and mirror coins 52. An order history 53 is maintained for each mirror blockchain and includes individual orders 54.

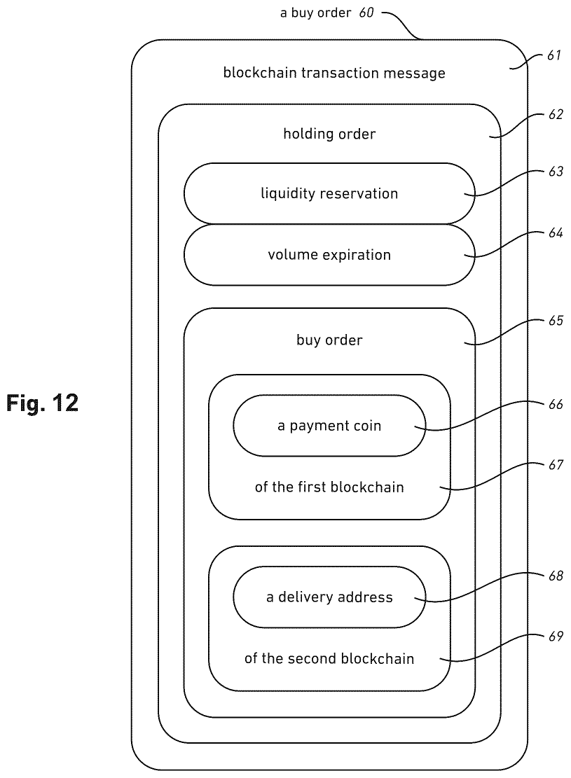

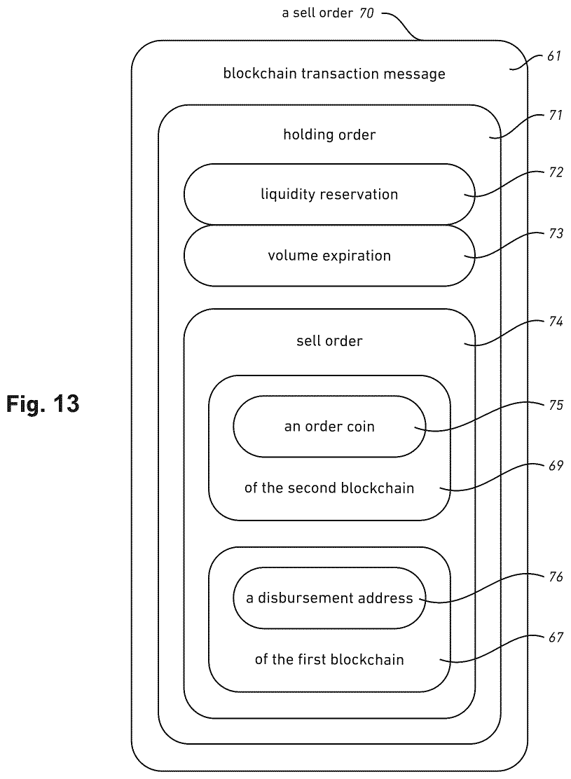

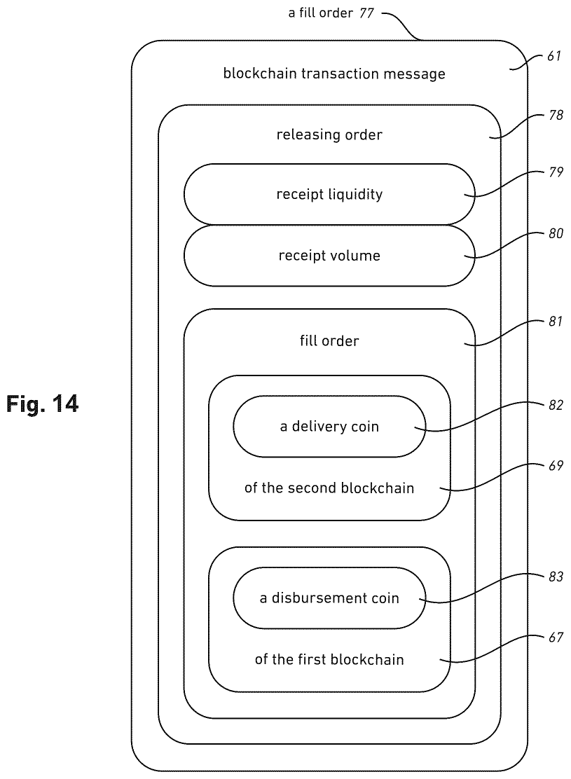

FIGS. 12, 13, and 14 depict blockchain transaction message structures, including buy orders 60, sell orders 70, and fill orders 77. FIG. 12 introduces a blockchain transaction message 41 for a buy order 40, setting a holding order 62 with a liquidity reservation 63 and a volume expiration 44 and specifying a payment coin 66 from the first blockchain 67 and a delivery address 68 on the second blockchain 69. FIG. 13 details a blockchain transaction message 61 for a unilateral sell order 70, setting a holding order 71 with a liquidity reservation 72 and a volume expiration 73, the sell order 74 involving an order coin 75 from the second blockchain 69 and a disbursement address 76 on the first blockchain 67. FIG. 14 illustrates a blockchain transaction message 61 for fill order 77, which is created after matching a buy order 60 and a sell order 70. The fill order includes a releasing order 78 with a receipt liquidity 79 and a receipt volume 80 that combines 81 a delivery coin 82 from the second blockchain 69 and a disbursement coin 83 from the first blockchain 67, ensuring atomic execution of transactions.

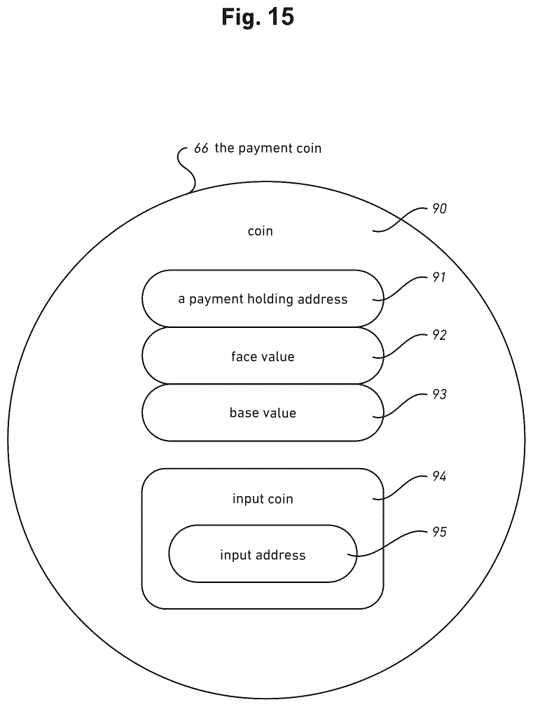

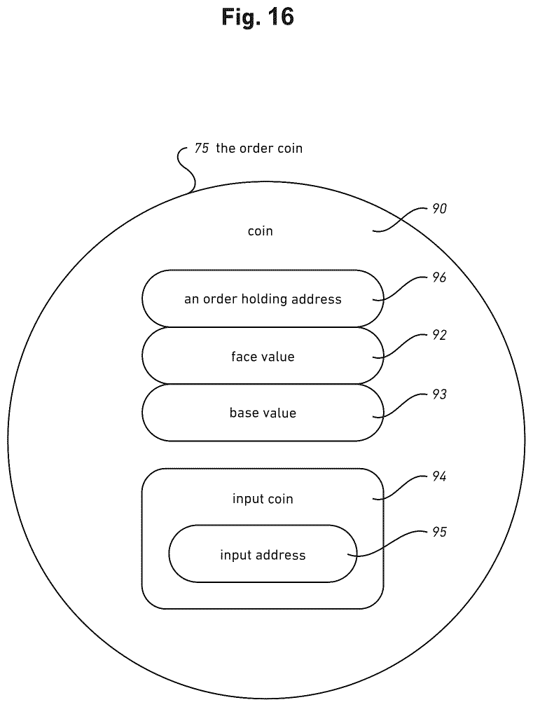

FIGS. 15, 16, 17, and 18 provide schematics of coin 90 structures, including the payment coin 66, the order coin 75, the delivery coin 82, and the disbursement coin 83. Each coin is associated with specific attributes, such as holding addresses 91, 96, face values 92, base values 93, input addresses 95 associated with an input coin 94, a delivery address 68, and a disbursement address 76. These schematics highlight the deterministic behavior of the crypto exchange medium, ensuring fraud resistance and seamless integration across blockchains.

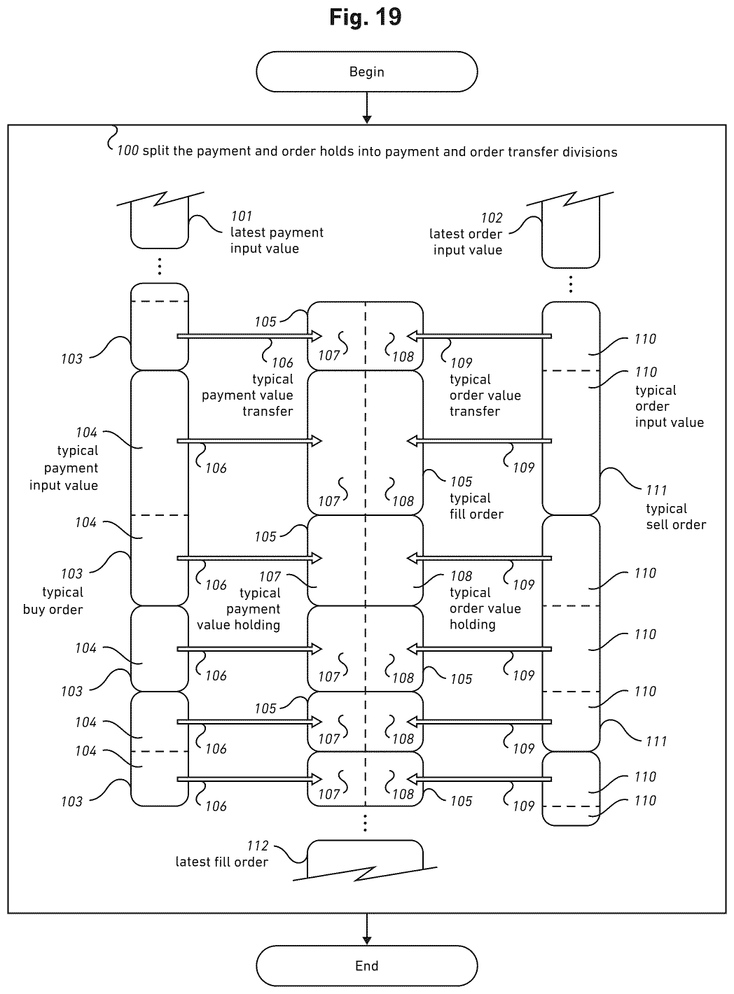

FIGS. 19-28 illustrate a working example or a set of working examples of the disclosed method in operation, showing specific transaction flows including the creation, matching, division, and settlement of orders.

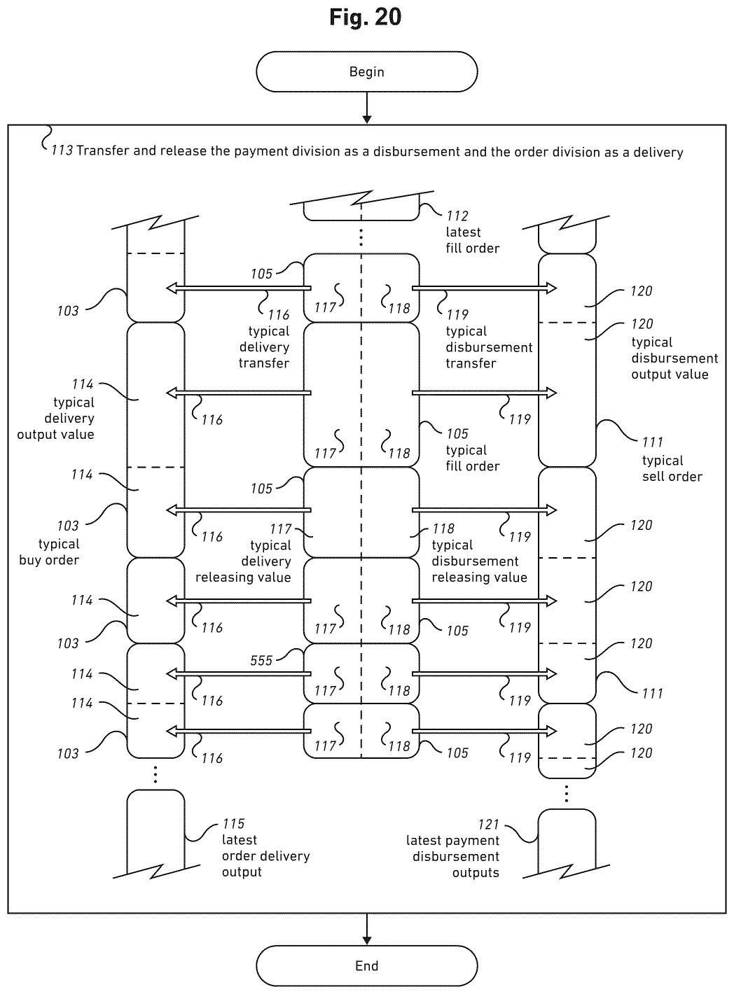

FIGS. 19-22 illustrate how orders are divided, matched, and released within the system. FIG. 19 presents a flowchart for splitting payment and order holds into transfer divisions, outlining the steps for buy orders, payment transfers, and order transfers. FIG. 20 continues the process by showing the release of payment divisions as disbursements and order divisions as deliveries, culminating in the finalization of the transaction.

FIGS. 19 and 20 present flowcharts detailing the payment and order division processes. In FIG. 19, the process begins with splitting payment and order holds into transfer divisions 100, by steps involving receiving the latest payment input value 101 and the latest order input value 102, splitting the payment input value 104 of a buy order 103 and the order input value 110 of a sell order 111, payment value transfer 106 and payment value 107 holding, order value transfer 109 and order value holding 108. The process matches the held payment value 107 and the held order value 108 to produce a fill order 105. The flow also tracks the latest fill order 112 as part of the matching and division process.

FIG. 20 continues with the release of payment divisions as disbursements 113 and order divisions as deliveries 116. The process further details the delivery output value 114, which represents the value delivered to the recipient, and the delivery releasing value 117, which indicates the amount released for delivery. The split fill order 555 includes the delivery releasing value 117 and the disbursement releasing value 118, which specifies the amount released for disbursement. Disbursement transfer 119 represents the actual transfer of the disbursed value, and disbursement output value 120 is the final value output as a result of the disbursement. The process culminates in output values 115 and 121, which finalize the transaction.

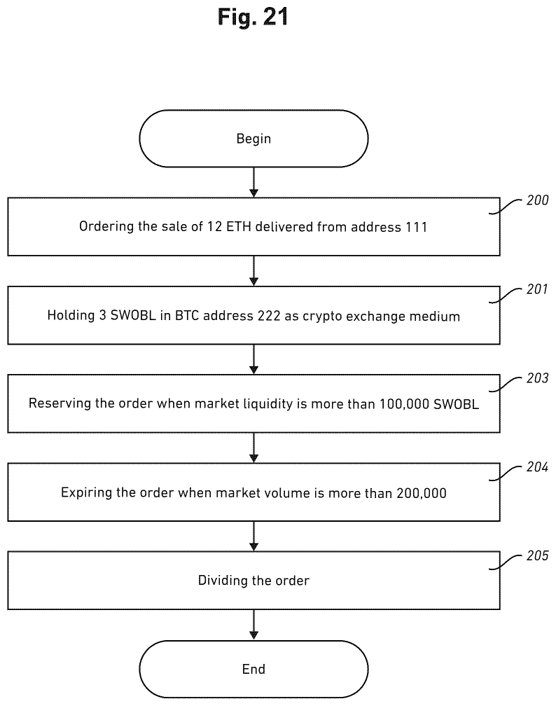

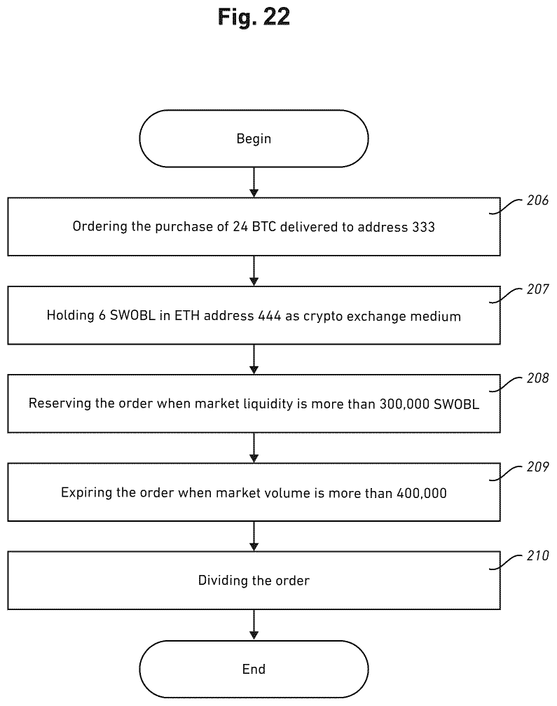

FIGS. 21 and 22 further demonstrate the division and matching of sale and purchase orders, including the processes of liquidity reservation, volume-based expiration, and order division. FIGS. 21 and 22 illustrate order-level flowcharts for sale and purchase transactions. FIG. 21 covers the sale of 12 ETH (200), Swopblock holdings (201), liquidity reservation (203), volume-based expiration (204), and order division (205). FIG. 22 addresses the purchase of 24 BTC (206), Swopblock holdings (207), liquidity reservation (208), volume-based expiration (209), and order division (210). These flowcharts emphasize the role of market liquidity and volume thresholds in transaction validation.

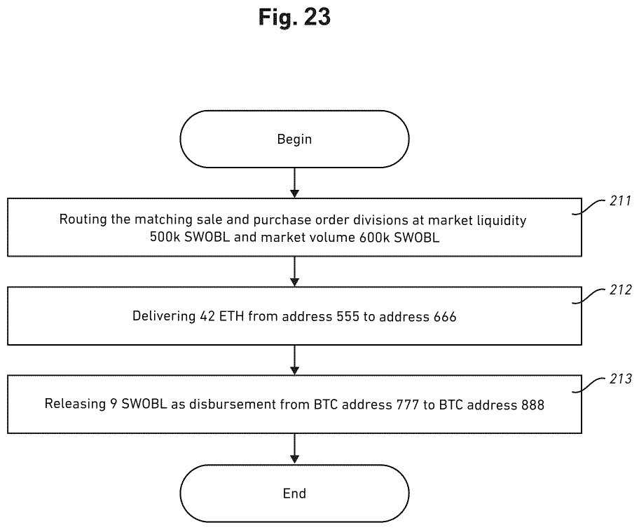

FIG. 23 outlines the routing, delivery, and disbursement sequence for matched sale and purchase orders, showing how fill blocks are used and how release is triggered. Routing begins at market liquidity 500k SWOBL and market volume 600k SWOBL (211), followed by the delivery of 42 ETH from address 555 to address 666 (212) and the release of 9 SWOBL as disbursement from BTC address 777 to BTC address 888 (213). This figure demonstrates the synchronization of liquidity and volume checkpoints with resulting asset transfers.

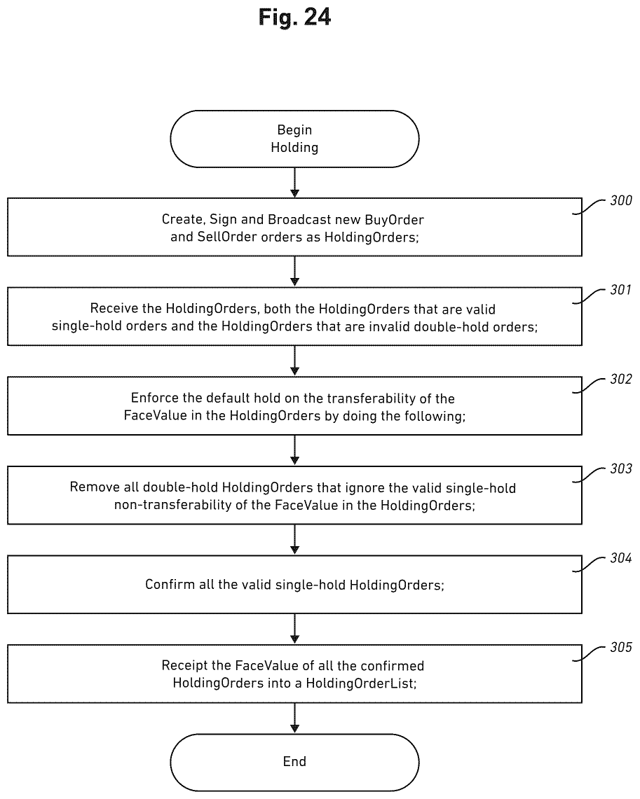

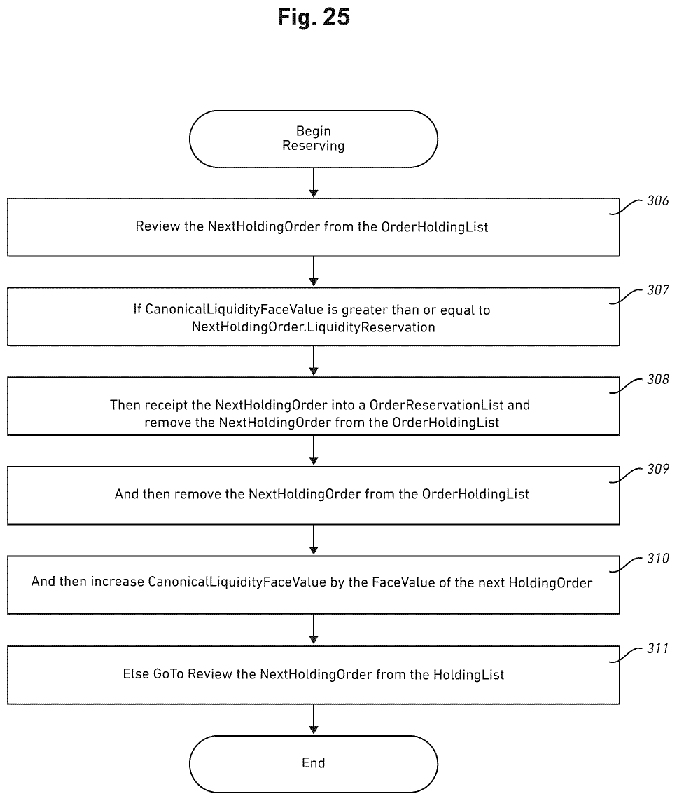

FIGS. 24, 25, 26, 27, and 28 provide a consolidated explanation of sequential processes, including holding, reserving, expiring, dividing, and routing. FIG. 24 illustrates the process of creating and broadcasting HoldingOrders (300), confirming valid single-hold orders (304), and receipting FaceValues into a HoldingOrderList (305). FIG. 24 illustrates the process of creating and broadcasting HoldingOrders (300), beginning with step 301, which involves receiving the holding orders, including both valid single-hold orders and invalid double-hold orders. In step 302, the system enforces the default hold on the transferability of the face value in the holding orders. Step 303 involves removing all double-hold holding orders that ignore the valid single-hold non-transferability of the face value. In step 304, all valid single-hold holding orders are confirmed, and in step 305, the confirmed FaceValues are receipted into a HoldingOrderList. FIG. 25 addresses liquidity-based reservation through a series of steps.

In FIG. 25, step 306 begins with reviewing the next holding order from the order holding list. Step 307 determines whether the canonical liquidity face value is greater than or equal to the face value of the next holding order, allowing for liquidity reservation if sufficient liquidity is available. In step 308, the next holding order is receipted into an order reservation list, and in step 309, it is removed from the order holding list. Step 310 then increases the canonical liquidity face value by the face value of the reserved holding order. If the liquidity is not sufficient, step 311 directs the process to review the next holding order from the holding list, continuing the evaluation cycle.

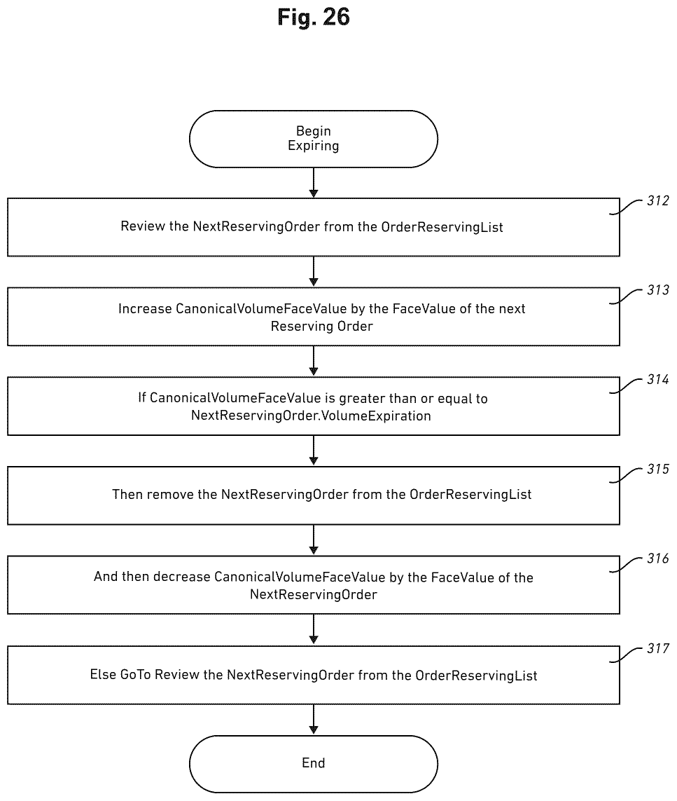

FIG. 26 focuses on volume-based expiration. In FIG. 26, step 312 begins with reviewing the next reserving order from the order reserving list. Step 313 increases the canonical volume face value by the face value of the next reserving order. Step 314 determines whether the canonical volume face value is greater than or equal to the face value of the next reserving order, indicating a volume expiration condition. If this condition is met, step 315 moves the next reserving order from the order reserving list, and step 316 decreases the canonical volume face value by the face value of the next reserving order. If the condition is not met, step 317 directs the process to review the next reserving order from the order reserving list, continuing the evaluation cycle.

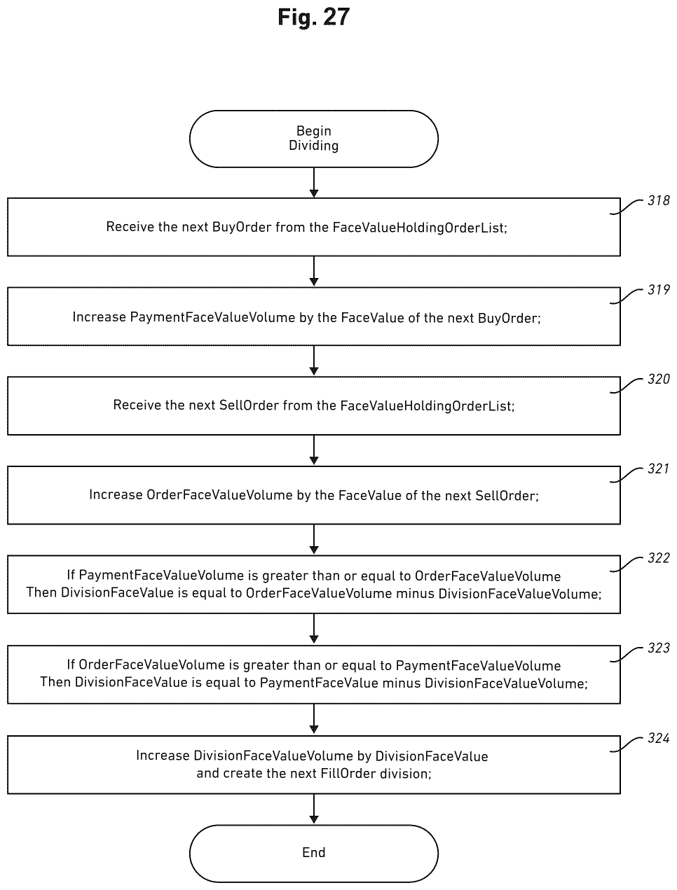

FIG. 27 illustrates the division of orders into fill orders, beginning with the step of receiving the next buy order from the face value holding order list (318). The process then increases the payment face value volume by the face value of the next buy order (319). Next, the system receives the next sell order from the face value holding order list (320) and increases the order face value volume by the face value of the next sell order (321). The process then compares the payment face value volume and order face value volume: if payment face value volume is greater than or equal to order face value volume, the division face value is set to the difference between order face value volume and division face value volume (322); if order face value volume is greater than or equal to payment face value volume, the division face value is set to the difference between payment face value and division face value volume (323). Finally, the division face value volume is increased by the division face value, and the next fill order division is created (324), completing the division and matching process.

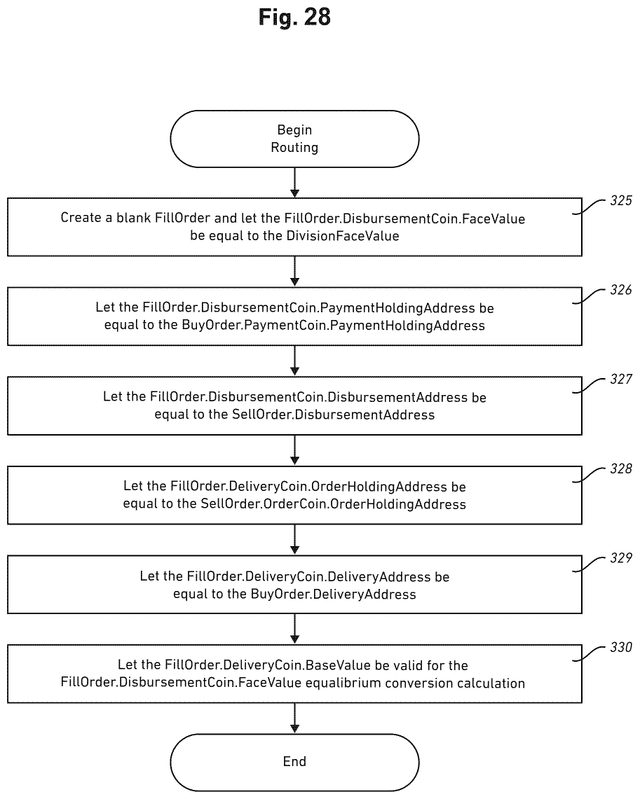

FIG. 28 provides a consolidated explanation of routing fill orders, beginning with step 325, which creates a blank fill order and sets the fill order disbursement coin face value equal to the division face value. In step 326, the fill order disbursement coin payment holding address is set to the buy order payment coin payment holding address. Step 327 assigns the fill order disbursement coin disbursement address to the sell order disbursement address. Step 328 sets the fill order holding address to the sell order holding address. In step 329, the fill order delivery coin delivery address is set to the buy order delivery address. Step 330 ensures that the fill order delivery coin base value is valid for the fill order disbursement coin face value equilibrium conversion calculation. This routing process specifies the disbursement and delivery attributes for each fill order and supports release triggers based on matching or market volume thresholds.

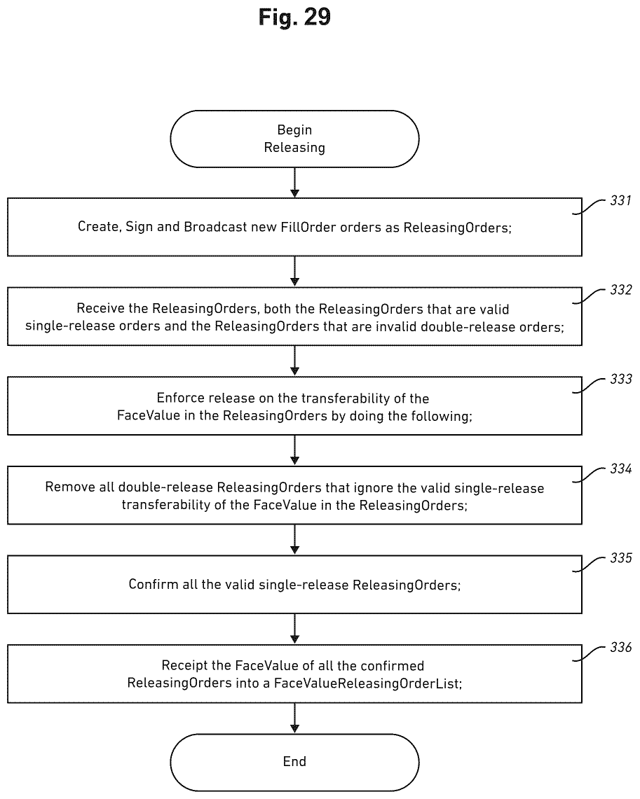

FIG. 29 shows a flowchart illustrating the process for releasing orders in a decentralized multi-blockchain exchange system. The process begins with creating, signing, and broadcasting new fill order orders as releasing orders 331. The system then receives the releasing orders, including both valid single-release orders and invalid double-release orders 332. Next, the process enforces release on the transferability of the face value in the releasing orders 333 by performing specific actions. All double-release releasing orders that ignore the valid single-release transferability of the face value are removed 334. The system then confirms all the valid single-release releasing orders 335. At the conclusion of the process, the face value of all the confirmed releasing orders is receipted into a face value releasing order list 336. These figures collectively illustrate the procedural elements that ensure secure and efficient transaction settlement.

It should be understood, of course, that the foregoing relates to exemplary embodiments of the invention and that modifications may be made without departing from the spirit and scope of the invention as set forth in the following claims.

What is claimed is:

1. A decentralized multi-blockchain crypto exchange system, comprising:
a plurality of blockchain networks;
a crypto exchange medium hosted on each of the blockchain networks and configured to interact with native assets of the blockchain networks;
a protocol-based mechanism to track balances of the crypto exchange medium and the native assets at addresses on the blockchain networks;
a protocol-based hold mechanism configured to unilaterally restrict transferability of the crypto exchange medium or native assets committed for exchange, without employing bilateral contracts or hash-time-locked contracts (HTLCs);
a protocol-based release mechanism configured to restore transferability of the crypto exchange medium or native assets upon fulfillment or expiration of exchange conditions; and
a consensus component configured to synchronize and trigger release of holds across the blockchain networks;
wherein the system atomically executes cross-chain exchange transactions such that all transfers succeed together or revert together, and no off-chain order-routing server executes any portion of the exchange.

2. The system of claim 1, wherein the protocol-based mechanism to track balances comprises an internal ledger maintained by the crypto exchange medium.

3. The system of claim 1, wherein the crypto exchange medium comprises a wrapped token configured to mirror a native asset on each blockchain network.

4. The system of claim 1, wherein the protocol-based hold mechanism comprises on-chain state flags implemented in smart contracts on each blockchain network.

5. The system of claim 1, wherein the consensus component is a multi-blockchain relay consensus component configured to generate relay proof values using one or more consensus mechanisms, determine a maximum relay proof value to trigger release of holds, and broadcast the maximum relay proof value for synchronization; and wherein the protocol-based release mechanism restores transferability of the divisions upon receipt of the maximum relay proof value broadcast by the multi-blockchain relay consensus component.

6. The system of claim 1, wherein the peer-to-peer, server-less communication channel employs a blockchain-native messaging protocol for secure transmission of exchange orders between user devices.

7. The system of claim 1, wherein the user devices comprise cryptographic wallets configured to digitally sign exchange orders and verify transaction confirmations.

8. The system of claim 1, further comprising a liquidity pool smart contract deployed on each blockchain network, the liquidity pool smart contract being configured to commingle the crypto exchange medium with native assets at the network native address.

9. The system of claim 1, further comprising a market-liquidity-based reservation criterion; wherein the market-liquidity-based reservation criterion comprises a specified cumulative trading volume threshold for exchange orders; and wherein exchange orders are activated or expired based on the market-liquidity-based reservation criterion.

10. The system of claim 1, wherein exchange orders that remain unfulfilled when the cumulative trading volume of the crypto exchange medium reaches the specified cumulative trading volume threshold are automatically invalidated.

11. The system of claim 1, wherein the system comprises more than two blockchain networks, and the protocol-based hold and release mechanisms operate across all blockchain networks in the pool.

12. The system of claim 1, wherein the consensus component uses a consensus mechanism selected from a proof-of-work, a proof-of-stake, and a combination thereof.

13. A method for atomic exchange of crypto assets across a plurality of blockchain networks, comprising:
receiving, on at least two blockchain networks, exchange orders from user devices, each exchange order specifying an amount of a crypto asset and an amount of a crypto exchange medium;
placing, by a protocol-based hold mechanism, a unilateral hold on the transferability of the crypto exchange medium or crypto assets committed for exchange on each blockchain network, without employing bilateral contracts or hash-time-locked contracts (HTLCs);
generating, by a consensus component, synchronization values across the blockchain networks to coordinate the release of the protocol-based holds;
determining, based on the synchronization values, when to restore transferability of the crypto exchange medium or crypto assets upon fulfillment or expiration of exchange conditions;
releasing, by a protocol-based release mechanism, the protocol-based holds to atomically execute the exchange such that all transfers of the crypto exchange medium and crypto assets across the blockchain networks succeed together or revert together;
wherein no off-chain order-routing server executes any portion of the exchange.

14. The method of claim 13, wherein the method is performed across more than two blockchain networks, and the protocol-based hold and release mechanisms operate across all blockchain networks in the pool.

15. The method of claim 13, further comprising dividing each face value of the crypto exchange medium or network native asset into a plurality of divisions, matching each division with another division for a division exchange, and restoring transferability of the divisions upon fulfillment or expiration of the division exchange, wherein each division exchange is matched and executed atomically.

16. The method of claim 13, wherein the protocol-based hold and release mechanisms operate unilaterally, such that each party may independently initiate an exchange order without pre-agreement or coordination with a counterparty.

17. The method of claim 13, further comprising generating relay proof values on the blockchain networks using a multi-blockchain relay consensus mechanism, determining a maximum relay proof value to trigger release of the protocol-based holds, and broadcasting the maximum relay proof value for synchronization across the blockchain networks.

18. The method of claim 13, further comprising applying a market-liquidity based reservation criterion having a specified cumulative trading liquidity threshold, and activating exchange orders that remain unexpired when the threshold is reached, making them available for matching, and further comprising invalidating exchange orders that remain unmatched when a cumulative trading volume of the crypto exchange medium reaches a predetermined market-volume-based expiration threshold.
